(19) United States
(12) Patent Application Publication
(10) Pub. No.: US 2026/0273907 A1
(43) Pub. Date: Sep. 17, 2026

(54) HETEROGENEOUS MULTIFUNCTIONAL POLYMER NETWORK STACK STRUCTURE

(71) Applicant: Ares Materials Inc., Dallas, TX (US)

(72) Inventors: David Arreaga, Garland, TX (US); Adrian Avendano-Bolivar, Prosper, TX (US); Jose Manuel Luna Vargas, Plano, TX (US); Maria Jose Santoyo de Leon, Richardson, TX (US); Damian Noriega-Mauricio, El Paso, TX (US)

(21) Appl. No.: 19/564,714

(22) Filed: Mar. 12, 2026

Related U.S. Application Data
(60) Provisional application No. 63/771,753, filed on Mar. 14, 2025.

(30) Foreign Application Priority Data
Mar. 10, 2026 (JP) 2026-037520
Mar. 11, 2026 (KR) 10-2026-0043775

(51) Int. Cl. B32B 27/40; B32B 27/08; B32B 38/00

(52) U.S. Cl. CPC B32B 27/40; B32B 27/08; B32B 38/00; B32B 2038/0076; B32B 2250/24; B32B 2255/10; B32B 2305/72; B32B 2305/74; B32B 2307/536; B32B 2307/56; B32B 2375/00; B32B 2398/10

(57) ABSTRACT

A heterogeneous multifunctional polymer network stack structure includes a plurality of mechanical zones, where the plurality of mechanical zones includes at least: a shock absorption layer and a high hardness layer. Each mechanical zone is partially cured to at least one adjacent mechanical zone, where the partial curing partially chemically bonds each of the mechanical zones to the at least one adjacent mechanical zone. A method for manufacturing a heterogeneous multifunctional polymer network stack structure includes partially curing a first layer to form a first mechanical zone of a plurality of mechanical zones. One or more additional layers are coated and partially cured on top of the first layer to form one or more additional mechanical zones partially cured to at least one adjacent mechanical zone. The plurality of mechanical zones is fully cured to complete polymerization between the first layer and the additional layers.

### CROSS-REFERENCE TO RELATED APPLICATIONS

This application claims priority to U.S. Provisional Patent Application No. 63,771,753, filed Mar. 14, 2025, and entitled “HETEROGENEOUS MULTIFUNCTIONAL POLYMER NETWORK STACK STRUCTURE,” Japanese Patent Application No. JP2026-037520, filed Mar. 10, 2026, and entitled “HETEROGENEOUS MULTIFUNCTIONAL POLYMER NETWORK STACK STRUCTURE,” and Korean Patent Application No. KR10-2026-0043775, filed Mar. 2026, and 11th entitled “HETEROGENEOUS MULTIFUNCTIONAL POLYMER NETWORK STACK STRUCTURE,” the entire disclosures of which are incorporated herein by reference for all purposes.

### BACKGROUND

Flexible displays are becoming the standard for foldable smartphones, tablets, and wearable electronics. Generally, flexible OLED and AMOLED displays (e.g., in foldable phones) require cover films that are capable of surviving pen-drop and ball-drop impact tests without being damaged. Traditional rigid glass cover lenses are too brittle when thinned for flexibility, so multi-layer polymer or hybrid laminates are engineered for impact dissipation purposes. These laminates typically stack layers of varying stiffnesses (Young's modulus) and glass transition temperatures (T_{g}) to grade the compliance through the thickness. An exemplary stack might include: a hardcoat surface layer (E≈3-3.5 GPa, T_{g}≥140° C.) for scratch resistance, one or more intermediate polymer layers (E≈2-3 GPa, T_{g}≈100° C.), a rubbery interlayer (E≈1-2 GPa, T_{g}≈30° C.), and a soft cushion layer (E≈0.1 GPa) at the base. The total thickness is constrained (often ≤100 μm) in order to maintain flexibility. This modulus-graded laminate is designed to absorb and attenuate impact energy, protecting the fragile display underneath.

Engineers are generally interested in how the layer order and thickness distribution in such stacks affect the peak stress/strain reaching the OLED panel, the critical drop height (failure threshold), and stress-wave propagation (reflection, transmission, and attenuation due to acoustic impedance mismatches between layers). Below, experimental studies, finite element analyses (FEA), and design guidelines are provided to address these factors. Quantitative findings that maximize impact energy dissipation under strict thickness constraints are analyzed (such as, for example: optimal layer sequences, thickness ratios, and any empirical scaling laws). Key concepts include “compliance grading”, “shock-absorbing polymer coatings”, “energy attenuation interfaces”, and “acoustic impedance matching” in relation to impact mitigation.

### Multilayer Design Strategies for Impact Dissipation

Graded-Stiffness Stacks vs. Alternating Layers: two broad design approaches exist for impact-dissipative films. One approach is the utilization of a monotonic modulus gradient (hard→medium→rubbery→soft from the outer surface inward). The other approach uses alternating hard/soft layers to induce interfacial effects. Bio-inspired studies (e.g. nacre-like composites) have shown that smoothly grading the compliance of interlayers leads to more uniform stress distribution and mitigates stress concentrations. In nacre's “compliance grading” motif, a stiff layer interfaces with a more compliant layer via a gradual modulus transition, reducing peak interfacial stresses. Numerical models confirm that step-wise compliance grading of the “mortar” layers in a stiff/soft layered structure can significantly redistribute strain and lower peak stress in the linear elastic regime. In other words, a gentle modulus gradient acts as an acoustic impedance gradient, allowing stress waves to be partially transmitted and dissipated in each layer rather than reflecting sharply at a single high-impedance boundary.

By contrast, alternating hard and soft layers (stiff/soft/stiff/soft) can exploit interface reflections and shear between layers to dissipate energy. This structure is seen in some biomimetic impact absorbers and “nacre-like” composites, where hard platelets and soft interlayers alternate. Under impact, the hard-soft interfaces promote mechanisms like delamination, frictional sliding, and multiple wave reflections, which can increase energy dissipation and crack deflection. For example, a bio-inspired alumina/polyurethane laminate with alternating hard and soft layers showed crack deflection and improved toughness under impact. However, for thin display cover films (≤100 μm), excessive interfaces could scatter light or reduce transparency, so a continuous gradient or a limited number of layers is preferred.

Typical Layer Functions: the hardcoat (outermost) layer is a thin (between 1-100 μm) high-T_{g} hard polymer or glass-like coating that resists scratching and distributes the initial impact force laterally. Beneath the hardcoat layer, intermediate stiff layers (e.g., PET or polyimide films, tens of μm thick) add structural support. A rubbery or elastomeric layer (e.g., a polyurethane or acrylic layer with T_{g} around room temperature or lower) serves as the primary energy absorber. Upon impact, the rubbery/elastomeric layer deforms and elongates, converting kinetic energy into elastic and viscoelastic strain energy (and some heat). Finally, a very soft cushion layer (low-modulus elastomer or adhesive, possibly 10-90 μm) applied directly on the display acts as a compliant buffer, further reducing the stress transmitted to the OLED panel by prolonging the impact pulse and spreading the load.

Importantly, the ordering can be varied. As an example, the softest layer may be positioned at the bottom of a stack (just above the display), which intuitively cushions the impact last (at the point of contact with the fragile panel). Alternatively, a soft layer may be positioned on the top of the stack (so the impactor first contacts a compliant surface) with harder layers positioned beneath the soft layer. The hard top layer may help prevent sharp penetrations and may also spread out a concentrated impact (especially for a pointed object like a pen tip), while the underlying soft layers cushion and decelerate the impact, lowering the peak force reaching the glass or OLED. If the order is reversed (soft outer layer over hard inner layer), the stack is vulnerable to sharp impactors which can “poke through” the soft layer and impart high stress to the hard sub-layer. This reverse stack with a soft outer skin is also more prone to cuts and isn't as good at distributing load. Thus, most designs use a descending modulus from the outside in. For example, Samsung's foldable display covers use a hard-coated polymer on the exterior and one or more softer polymer or OCA (optically clear adhesive) layers are positioned beneath the hard-coated polymer; the one or more softer polymer/OCA layers are tuned to absorb shock before it reaches the ultra-thin glass or OLED stack.

In light of the aforementioned, some alternation of stiff and compliant sub-layers can fine-tune impedance matching. In cases where total thickness allows, designers can insert a thin stiff layer in the middle of a thick soft layer (or vice versa) to reflect a portion of the stress wave and “split” the impact pulse into two smaller pulses. This may be beneficial if timed correctly: a reflected tensile wave can interfere with the incoming compressive wave, reducing the net stress at certain points (a principle akin to wave cancellation). However, achieving this effect in a <150 μm film is challenging. A more common approach involves dual-layers: one relatively high-modulus elastomer layer and one lower-modulus elastomer layer in a stack (which has shown remarkable results).

### Finite-Element Modeling Insights

Finite-element analyses (FEA) of multilayer cover films have provided insight into stress-wave propagation and damping. When an impact occurs, a stress wave (or shock wave, for very high strain rates) travels through the layers. At each interface, part of the wave reflects and part transmits, governed by acoustic impedance (Z=ρ·c, where c=wave speed in the material). A large impedance mismatch (such as, for example, between a very stiff layer and a very soft layer) can cause strong reflections. Reflected waves can be harmful if they reverberate back into the substrate, however, they can also keep some energy out of the next layer. Optimally, an individual would want to gradually impedance-match from the impactor to the panel—neither reflecting everything at once (which would concentrate energy at one interface) nor transmitting everything (which would dump the shock entirely into the panel). A graded stack serves this purpose by incrementally transitioning the wave from high to low impedance. Studies on laminated glass (glass and PVB layers) demonstrate that a soft interlayer may both dissipate energy and cause wave reflections that rapidly reduce the stress magnitude as the wave propagates outward. In drop tests on glass with a polymer interlayer, high-speed photography showed that crack propagation speeds dropped significantly when the wave hit the soft layer, indicating energy absorption and reflection.

In simulation models, the polymers' viscoelastic damping is crucial. Many FEA works use Rayleigh damping (a combination of mass-proportional and stiffness-proportional damping) to approximate the frequency-dependent damping of polymer layers. This helps capture the real behavior where a rubbery layer will absorb more energy at higher strain rates (near its T_{g}, the loss modulus is high). In fact, strain-rate dependence is a key factor: a compliant layer that seems “soft” under slow loading can behave stiffer under the high strain rates of an impact, affecting how stress is distributed. Thus, advanced FEA incorporates hyperelastic-viscoelastic material models for layers like OCA/PSA (pressure-sensitive adhesive). According to Han et al. (“Highly flexible cover window using ultra-thin glass for foldable displays.” J. Mech. Sci. Tech., 2021), assuming that the OCA is purely linear elastic in rollable display models can lead to inaccuracies. Similarly, for impact scenarios, capturing the time-dependent response is necessary to predict whether the layer will respond in a rubbery energy-dissipative manner or a glassy, stiffer manner.

Using calibrated models, designers can perform parametric studies on layer thickness and modulus. Generally, FEA confirms that adding a thicker soft layer lowers the peak stress in a substrate. However, diminishing returns occur once a certain thickness is reached. Too thick of a cushion can even slightly increase stress for a sharp impact because the indenter travels deeper before the force builds up (leading to a concentrated puncture-like loading on the panel). In one simulation study of a rollable AMOLED module stack, introducing an “impact absorption layer” as part of a hybrid cover significantly reduced the accumulated strain in the OLED and balanced rollability with impact resistance. The optimized design leveraged the neutral plane concept (to minimize bending stress) while using a soft layer to absorb impact shock.

Another analytical consideration to discuss is stress wave duration, or pulse spreading. A softer, compliant layer may lengthen the impact contact time (like a crumple zone), thereby reducing the force peak by impulse-momentum considerations. An experiment regarding stress wave duration on acrylic display adhesives identified two mechanisms for shock absorption: energy dissipation into the PSA material (true damping) and extended contact time (which lowers peak force). FEA confirms: a cushion that “gives” more will spread the impact over a longer time, lowering the spike of stress. However, if the cushion gives too much (low modulus and thick), a sharp object may bottom out on the next layer quickly—hence an appropriate intermediate stiffness or multi-layer combo often performs best.

### Experimental Results: Impact Tests and Data

Practical drop tests on multilayer films underscore the performance differences between various stacking sequences. A compelling example is provided in 3M® (a registered trademark of 3M company, a Delaware corporation) PCT Publication WO2018057774A1 for a “protective display film” using a thin glass and a polymer stack. In their tests, a 4.3 g steel ball and a 5.5 g stylus (pen) were dropped from progressively greater heights onto sample constructions to determine the critical drop height at which no visible damage (no crack or permanent mark) occurs. The total laminate thickness was ~0.24 mm, including a 100 μm ultra-thin glass and about 136 μm of a special polyurethane “energy dissipation layer.” Some configurations and results from Table 7 of the PCT publication are presented as follows:

Example A/B/C—100 μm glass+~136 μm polyurethane cushion (cross-linked, T_{g}≈−20° C.). No damage, even at maximum test heights: 27 cm ball drop, 16 cm pen drop (the limit of the apparatus). In other words, the laminate could likely withstand even higher drops. All-glass cracks were completely prevented within those limits.

Example D—Same as above but with an added 50 μm PET hard layer on top (attached via a thin OCA). No damage at 27 cm ball drop; pen drop survived up to 16 cm. The pen test result (16 cm) was slightly lower than the “>16 cm” of A-C, suggesting that adding a stiff PET top layer slightly reduced the pen-impact tolerance (likely because the PET is less compliant than the exposed polyurethane, so it doesn't dampen the pen impact as effectively). Still, the performance remained excellent and hit the apparatus limit.

Comparative 1-100 μm glass+only a thin OCA (25 μm)+PET 50 μm (no PU cushion). Ball drop only 4 cm; pen drop 10 cm until damage. This is essentially a baseline with just a hard PET cover and a minimal soft layer. It survived only very small drops (a 4 cm drop of the 4.3 g ball caused glass cracking).

Comparative 2-100 μm glass+thicker OCA (~75 μm)+PET 50 μm-Ball drop 7 cm; pen drop 6 cm safe height. Interestingly, making the adhesive layer thicker improved the ball-impact tolerance (from 4 cm to 7 cm) but worsened the pen tolerance (10 cm down to 6 cm). This highlights the shape effect: a thicker soft layer helped with the blunt ball (absorbing more energy), but for the sharp pen, a thicker soft layer allowed the tip to indent more deeply, concentrating stress and leading to earlier failure unless another stiff layer intervenes.

Key takeaways of the impact tests: Introducing a proper soft cushion layer (low-T_{g} PU) gave a ~4× increase in pen-drop survival height (from ~6 cm-10 cm to ≥16 cm) and even more dramatic improvement in ball-drop height (from ~4 cm-7 cm to ≥27 cm). In essence, the modulus-graded stack turned catastrophic brittle fracture into a non-damaging elastic event for drops within those ranges. The fact that a comparative sample with only adhesive did worse in pen test when the adhesive was thicker underscores that an optimal combination of layers is needed-both a sufficiently soft layer to cushion and a somewhat stiff distribution layer to prevent excessive indentation by sharp objects is preferred.

Another study comes from Samsung's AMOLED research: Kim et al. (“Highly Recoverable and Robust Rollable AMOLED with Smart Elastomer,” J. Soc. Info. Display, 2025) presents a “double-stacked elastomer” cover structure for a rollable AMOLED display. Two elastomer layers are utilized: one high-modulus layer and one low-modulus layer stacked together. This smart layering achieved a pen-drop critical height increase from 2 cm (baseline) to 9.5 cm. In other words, the same AMOLED panel that would be damaged by a 2 cm pen drop can survive a nearly 10 cm pen drop after adding the dual-elastomer film. The top protective elastomer embodies a tensile hardening behavior, meaning it stiffens at high strain. This property is very important-under the sudden impact of the pen, the top layer stiffens (distributing the load) while still being elastomeric enough to damp energy. It was further noted that this top layer “enormously reduced the strain” experienced by the OLED panel and adhesive and “remarkably increased the energy damping effect”, thereby raising the failure threshold in the pen drop test. The result provides a much more robust rollable display that does not show black spot failures until significantly higher drop energy is applied. This approach is effectively a two-layer modulus alternation (a relatively stiff elastomer over a softer elastomer) that balances hardness and cushion in a thin stack.

Adhesive Layer Tuning: Even the pressure-sensitive adhesive (PSA) used in assembly can be engineered for shock absorption. Back et al. (“Shock Absorption of Semi-IPN Acrylic PSA for Mobile Display.” Int. J. Adhes. Adhesives, 2020) developed a semi-interpenetrating network (semi-IPN) acrylic PSA to bond display films. By introducing a crosslinked network into a linear polymer matrix, a higher storage modulus with decent damping is achieved. Within Back, a “shock absorption ratio (ΔF)” was measured, which is essentially the fraction of impact force absorbed by a film in a falling dart test. The semi-IPN PSA with optimized crosslinker content showed ΔF=31.2% (compared to 24.6% for a conventional PSA). This ~27% improvement in energy absorption is attributed to the IPN structure, which is likely to increase yielding and viscoelastic energy dissipation under impact. Importantly, this result was achieved while maintaining practical adhesion (peel strength>10N/25 mm) and not significantly increasing stiffness at low strain. Such damping-optimized OCA layers act as additional shock absorbers in the stack. In flexible display modules, it's noted that the PSA layer serves as a buffering layer, reducing stress on the device during bending and impact. Manufacturers (e.g., Sekisui Chemical) have developed specialized impact-resistant OCAs for foldable OLEDs, claiming improved drop test outcomes while retaining clarity.

Overall, current display protection solutions rely on laminated layers of different materials, leading to: increased risk of delamination and interface failures, reduced durability, and optical inconsistencies. Existing display protection solutions suffer from the use of separate laminated materials, which creates weak interfaces prone to delamination and mechanical failure. Optical mismatches between stacked layers are also an issue, which leads to: light distortion, reduced color accuracy, and difficulty achieving true blacks. The existing display protection solutions also embody limited mechanical functionality, which requires trade-offs between hardness, shock absorption, and adhesion. Additionally, existing solutions also do not explicitly address the issue of crease formation in display films after repeated folding cycles. The challenge remains in achieving flexible display protection solutions that are not hindered by the aforementioned limitations.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of a cross-sectional view of a heterogeneous multifunctional polymer network stack structure in accordance with certain embodiments of the present disclosure;

FIG. 2 is an illustration of a cross-sectional view of a heterogeneous multifunctional polymer network stack structure positioned on a polymer substrate in accordance with certain embodiments of the present disclosure;

FIG. 3 is an illustration of a cross-sectional view of a heterogeneous multifunctional polymer network stack structure positioned on an OLED display module in accordance with certain embodiments of the present disclosure;

FIG. 4 is an illustration of a method for manufacturing a heterogeneous multifunctional polymer network stack structure in accordance with certain embodiments of the present disclosure;

FIGS. 5A-5C are illustrations of cross-sectional views of heterogeneous multifunctional polymer network stack structures each including layers with varying elastic moduli in accordance with certain embodiments of the present disclosure;

FIG. 6 is an illustration of a cross-sectional view of a heterogeneous multifunctional polymer network stack structure including layers with varying elastic moduli in accordance with certain embodiments of the present disclosure;

FIG. 7 is an illustration of a cross-sectional view of an optical laminate in accordance with certain embodiments of the present disclosure; and

FIG. 8, which is an illustration of a cross-sectional view of a flexible display in accordance with certain embodiments of the present disclosure.

The illustrated figures are only exemplary and are not intended to assert or imply any limitation with regard to the environment, architecture, design, or process in which different examples may be implemented.

### DETAILED DESCRIPTION

The present disclosure relates generally to the field of display technology, and more particularly to a heterogeneous multifunctional polymer network stack structure utilizing thiol-ene thermoset polymers. In regard to the present disclosure, the term “mechanical zone” refers to a polymer layer of a heterogeneous stack structure that has been initially partially cured prior to an additional polymer layer being deposited onto the polymer layer and then subsequently fully cured once all desired/necessary polymer layers have been added to a polymer network stack structure. It is further noted that a mechanical zone may embody different mechanical properties than a mechanical zone that it is being deposited on. The term “full cure” or “full curing” refers to a second or secondary curing process performed on a plurality of mechanical zones to facilitate covalent bonding between layers of the plurality of mechanical zones. It is further noted that a “full curing” may correspond to at least approximately 95% conversion of reactive functional groups, which generally corresponds to the transition of a polymer from a liquid or partially crosslinked state to a substantially solid polymer network. The term “seamless,” in relation to adjacent mechanical zones, may refer to polymer networks from adjacent mechanical zones that interpenetrate and chemically bond during sequential curing steps and form a continuous heterogeneous polymer network, where the mechanical zones do not include a discrete laminated interface. This interfacing of polymer networks creates a gradual transition region rather than a sharp boundary between polymer layers/zones.

For the purposes of this disclosure, the term “high hardness”, in relation to a mechanical zone, refers to a mechanical zone configured to provide surface protection and scratch resistance. The mechanical zone may be characterized using one or more mechanical metrics, for example: Martens hardness, indentation hardness, Young's modulus, storage modulus, and pencil hardness. Example embodiments of a “high hardness” mechanical layer may include on or more of: a Martens hardness >250 MPa, a pencil hardness ≥1H without additional hardcoat layers, and/or a pencil hardness up to ~5H or greater when used with additional hardcoat coatings. It is noted that a “high hardness” mechanical zone may alternatively be referred to as a hardcoat mechanical zone.

For the purposes of this disclosure, the term “high adhesive properties”, in relation to a mechanical zone, may refer to a mechanical zone capable of structurally bonding a stack structure to a substrate such as a display module or an optical substrate. Adhesion may be characterized using standard methods, for example: crosshatch adhesion tests (e.g., ASTM D3359) with ratings of approximately 4B-5B, and/or peel strength values typically ranging from approximately 0.5 N/cm to 10 N/cm (depending on the substrate and formulation).

For the purposes of this disclosure, the term “shock absorption layer”, in relation to a mechanical zone, may refer to a mechanical zone configured to dissipate mechanical energy during impact, bending, or folding events. These layers may typically: exhibit relatively low modulus and higher damping characteristics compared to the high hardness mechanical zone and may embody a storage modulus in the range of approximately 1 kPa to 50 MPa.

Further in regard to the present disclosure, the term “adhesive” can include both permanent adhesives and pressure-sensitive adhesives (tacky adhesives). It is noted that a pressure-sensitive adhesive may be repositionable and may function as a permanent adhesive by being subjected to a post-application treatment such as irradiation or heating with ultraviolet radiation. Further in regard to the present disclosure, the term “optically clear” refers to a material having a haze value of less than 1% across the wavelength range 400 to 700 nm, a yellow index of less than 1, and a luminous transmittance of greater than 90% across the wavelength range 400 to 700 nm (using air as a reference). It is noted that haze can be determined in accordance with JIS K 7136 (2000) and luminous transmittance can be determined in accordance with JIS K 7361 (1997). Additionally, the term “optically clear” generally refers to a state in which air bubbles, phase separation, and optical defects cannot be visually observed. Further in regard to the present disclosure, the term “storage modulus (G′)” refers to the storage modulus of a material at a specific temperature when a rate of temperature increase is measured at 5° C./min, and viscoelasticity is measured in a 1.0 Hz shear mode within a temperature range of −20° C. to 60° C. In embodiments, materials/polymers that make up the mechanical zones in the heterogeneous multifunctional polymer network stack structure may comprise a storage modulus ranging from 1 kPa to 5 GPa. In more specific embodiments, disclosed high hardness zones may comprise a storage modulus within a range of approximately 500 MPa to approximately 8 GPa; disclosed intermediate transition zones may comprise a storage modulus within a range of approximately 1 MPa to approximately 500 MPa; and disclosed shock absorption zones may comprise a storage modulus within a range of approximately 1 kPa to approximately 50 MPa.

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

Unless otherwise indicated, all numbers expressing quantities of components, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Presented herein is a heterogeneous multifunctional polymer network stack structure. The stack structure includes a polymer network comprising a plurality of mechanical zones, where the plurality of mechanical zones includes at least: a shock absorption layer and a high hardness layer. Each mechanical zone of the plurality of mechanical zones is partially cured to at least one adjacent mechanical zone, where the partial curing partially chemically bonds each of the mechanical zones to the at least one adjacent mechanical zone.

Also presented herein is a method for manufacturing a heterogeneous multifunctional polymer network stack structure. The method includes partially curing a first layer to form a first mechanical zone of a polymer network comprising a plurality of mechanical zones, where the first layer comprises one of: a shock absorption layer and a high hardness layer. One or more additional layers are coated and partially cured on top of the first layer to form one or more additional mechanical zones of the polymer network partially cured to at least one adjacent mechanical zone, where at least one of the one or more additional layers comprise one of: the shock absorption layer and the high hardness layer. The polymer network is fully cured to complete polymerization between the first layer and the one or more additional layers.

Presented in embodiments herein is a heterogeneous multifunctional polymer network stack structure embodying a single, integrated polymer network having distinct mechanical zones for hardness, shock absorption, and adhesion. The stack structure may embody refractive index matching (of zones) that results in seamless optical performance that improves true color transmission and deep blacks. Additional embodiments may provide a stack structure utilized in one or more layers of display devices. By eliminating laminated layers, reducing failure points, and enabling refractive index-matched optics, the disclosed stack structures provide enhanced durability, seamless optical clarity, and enhanced foldability when compared to existing screen technologies.

### Effects of Layer Thickness Ratios

Within a stack having a fixed total thickness, it is contemplated how thickness should be allocated to each layer. While specific “optimal” numbers vary by material, some general guidelines emerge:

1) Prioritize a substantial soft layer (low modulus) for energy absorption, but not as the very outermost surface. The cushion layer often occupies the largest fraction of the thickness. For example, in the 100 μm total stack example previously presented, ~50-70% of the stack is a soft PU interlayer. If the soft layer is too thin, the stack bottoms-out quickly. Studies on laminated glass show thicker interlayers greatly improve impact resistance up to a point of diminishing returns.

2) Maintain a thin hard top layer for surface protection. A few microns to tens of microns of hardcoat or high-modulus film can distribute the impact. However, making the hard layer too thick eats up volume and can potentially transmit more force. For example, in reference to Comparative 1 vs Comparative 2 previously presented, both stacks have the same 50 μm PET; the difference was in adhesive thickness; it was concluded that PET was necessary for surface hardness but was not sufficient for impact by itself).

3) Use intermediate modulus layers as needed to prevent a drastic two-layer mismatch. If the top hardcoat is extremely thin (like a coating), one intermediate film (e.g. PET or CPI-colorless polyimide, around 20-50 μm thick) can serve as a semi-rigid backbone that also shares some strain with the cushion. This intermediate layer, with E in the 2-3 GPa range, also helps control the device's bending neutral axis without being brittle.

4) Softest layer near the panel: the layer in contact with the OLED or ultra-thin glass is very compliant (for example, a silicone-based OCA of modulus on the order of 0.01 GPa-0.1 GPa, or even ~MPa range). This provides a gentle interface of the fragile panel-reducing shear and tensile stress transferred into the panel. Within WO2018057774A1 (referenced previously), a coupling layer positioned between the film stack and the display with a shear modulus≤0.3 MPa (0.0003 GPa) is disclosed in order to protect the OLED. Essentially, the last layer “decouples” the shock. It may be thin (a few tens of μm) as long as it's very soft.

5) Symmetry for bidirectional impact: if impacts could come from either side (not typical for a bonded cover, but relevant for encapsulation films), a symmetric layering may be used. But for a cover film, only the outward-facing side sees impact, so the grading can be one-directional.

Empirically, 50% or more of the thickness may be dedicated to the primary energy-absorbing layer (or layers). In an embodiment in which a stack includes a constrained total thickness, maximizing the volume of the lowest-modulus material yields the best energy absorption per unit thickness-provided that its loss factor is high. However, for point impact (like a stylus), one rule of thumb is to provide at least one stiff layer of about 25-50 μm near the surface to prevent deep indentations. An exemplary ratio may be, for example, 20% hard+30% medium+50% soft (by thickness).

Finally, damping (loss modulus or tan δ) is as important as elastic modulus. A material that is soft but purely elastic (aka, low hysteresis) will just store and release the energy (possibly reflecting it). A material with higher internal damping (high tan δ at the impact frequency) may convert more of that mechanical shock into heat, improving protection. For instance, the polyurethane in WO2018057774A1 has a tan δ peak≥0.5 in the usage range—indicating significant energy loss—while maintaining an elastic modulus above 0.9 MPa so that the polyurethane isn't too gel-like. This balance of soft-but-damping is salient. As a rule: choose interlayer materials near their glass transition temperature (for high damping), but not above T_{g} (to avoid softness that compromises structural integrity). This often correlates with a T_{g} a bit below room temperature (~0-30° C.) for primary cushion layers, so at room temperature the primary cushion layers are rubbery with a high loss factor.

Multilayer polymer/hybrid films designed for display drop protection leverage compliance grading and interface engineering to drastically improve impact resistance. A hard exterior (for scratch resistance and force distribution) combined with progressively softer, high-damping inner layers may reduce the peak stress transmitted to the OLED panel by reflecting and absorbing shock waves. Experiments show that such stacks can increase the critical drop height by several-fold—e.g. from single-digit centimeters to tens of centimeters in standardized tests. A salient configuration uses a thick low-modulus layer (or layers) to maximize energy dissipation, and requires at least a thin high-modulus layer to guard against sharp penetrations. Stress-wave reflections at layer interfaces, usually seen as a negative (causing internal echoes), are utilized beneficially: a large impedance mismatch at the cushion/panel interface reflects a portion of the wave back upwards, sparing the fragile panel. Meanwhile, intermediate layers may be tuned to acoustically “match” adjacent layers, smoothing the stress transfer and preventing any one interface from shouldering the entire shock.

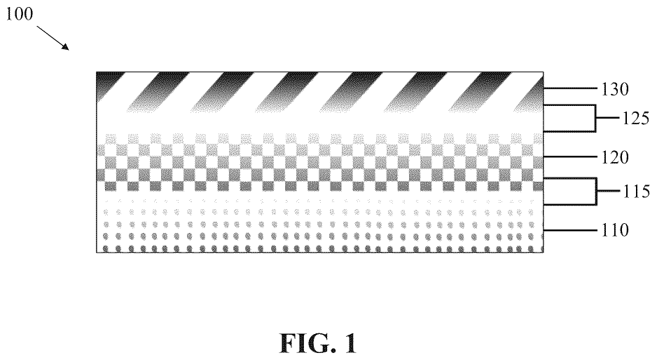

FIG. 1 is an illustration of a cross-sectional view of a heterogeneous multifunctional polymer network stack structure in accordance with certain embodiments of the present disclosure. According to one or more embodiments of the present disclosure, one or more mechanical zones of heterogeneous multifunctional polymer network stack structure 100 may include thiol-ene thermoset polymers for use in display technologies. Stack structure 100 includes multiple mechanical zones 110,120,130 that are chemically bonded to one another via partial curing and subsequent full curing processes. The partial and full curing processes may create a seamless transition area between each of the mechanical zones 110,120,130, reducing interfacial structure between mechanical zones 110,120,130 that would normally exist in typical polymeric stack structures. As a result, mechanical zones 11,120,130 are encompassed within a single, unified polymer network, eliminating the need for laminated layers and thus reducing interface failures.

Mechanical zones 110,120,130 may provide seamless optical clarity and may include: a high hardness surface mechanical zone 110 for scratch resistance (in embodiments, Martens hardness>250 MPa; pencil hardness of 1H without additional hard coats and 5H with additional hard coats), a shock absorption mechanical zone 120 for impact protection, and an adhesive mechanical zone 130 for structural bonding purposes (may be an optional third mechanical zone, in embodiments, utilized for integration of stack structure 100 into display modules, etc.). Shock absorption mechanical zone 120, in embodiments, is further configured to: 1) absorb impact forces to prevent mechanical failure of stack structure 100, and 2) eliminate stress localization to prevent crease formation in stack structure 100. Interfacial regions 115,125 are areas between mechanical zones 110,120,130 that act as transition regions between mechanical zones 110,120,130. Rather than forming a discrete bonding interface, interfacial regions 115,125 define regions in which polymer networks from adjacent layers/mechanical zones partially interpenetrate during partial curing processes. As curing progresses, these regions may contain a mixture of polymer chains that originate from both layers. As a result, the transition between materials may occur gradually over a finite thickness rather than at a sharp interface. During the full curing process, covalent bonding occurs within interfacial regions 115,125, contributing to the mechanical zones 110,120,130, forming an interpenetrating polymer network.

In relation to optical properties, stack structure 100, in embodiments, may be optically clear and may additionally include the following optical properties: a haze value of less than 1%, a yellow index of less than one, and an optical transmission rate of greater than 90% (using air as a reference), a low birefringence (in embodiments, less than 100 nm/cm), and matched refractive indices (between layers) for seamless optical integration (allowing true color transmission and enhanced black contrast). Stack structure 100 additionally may provide an enhanced durability over general stack structures, which may lead to the stack structure being able to withstand over 200,000 folding cycles at a 0.5 mm-4 mm bending radius even at extreme temperatures (−25° C. to 65° C.). In additional embodiments, stack structure 100 may include mechanical zones besides those mentioned previously, which can allow for additional functional customization. Overall, the properties disclosed may increase optimization of stack structure 100 for utilization in next-generation displays.

An exemplary embodiment of the disclosed subject matter includes a heterogeneous multifunctional polymer network stack structure. The stack structure comprises a plurality of mechanical zones, where the plurality of mechanical zones includes at least: a shock absorption layer and a high hardness layer. Each mechanical zone of the plurality of mechanical zones is partially cured to at least one adjacent mechanical zone, where the partial curing partially chemically bonds each of the mechanical zones to the at least one adjacent mechanical zone.

In an additional embodiment, at least one of the plurality of mechanical zones comprises a thiol-ene thermoset polymer.

In an additional embodiment, at least one of the plurality of mechanical zones comprises: a multifunctional thiol compound and at least one of: a multifunctional ethylenically unsaturated compound and a tetrafunctional urethane monomer. In a further embodiment, the multifunctional thiol compound is selected from: pentaerythritol tetrakis(3-mercaptopropionate), pentaerythritol tetrakis(3-mercaptobutylate), trimethylolpropane tris(3-mercaptopropionate), trimethylolpropane tris(3-mercaptobutylate), dipentaerythritol hexakis (3-mercaptopropionate), and 1,3,5-tris[2-(3-mercaptobutanoyloxy)ethyl]-1,3,5-triazine-2,4,6 (1H,3H,5H)-trione. In a further embodiment, the multifunctional ethylenically unsaturated compound is selected from: tris(2-acryloyloxyethyl) isocyanurate, trimethylolpropane triacrylate, pentaerythritol triacrylate, dipentaerythritol pentaacrylate, dipentaerythritol hexaacrylate, diallyl phthalate derivatives, and other multifunctional acrylate or allyl-functional monomers capable of participating in thiol-ene polymerization. In a further embodiment, the tetrafunctional urethane monomer is selected from: tetraallyl urethane derivatives, tetraacrylate urethane oligomers, and other urethane-based monomers containing four reactive allyl or acrylate functional groups.

In an additional embodiment, the plurality of mechanical zones is fully cured after the partial curing of each of the mechanical zones of the plurality of mechanical zones to form an interpenetrating polymer network.

In an additional embodiment, the plurality of mechanical zones further comprises an additional mechanical zone having high adhesive properties. In a further embodiment, the additional mechanical zone is configured to structurally bond to a display module.

In an additional embodiment, the high hardness layer comprises a Martens hardness greater than 250 MPa.

In an additional embodiment, the plurality of mechanical zones is tunable via thickness and proportion ratios in order to enhance mechanical performance of the heterogeneous multifunctional polymer network stack structure.

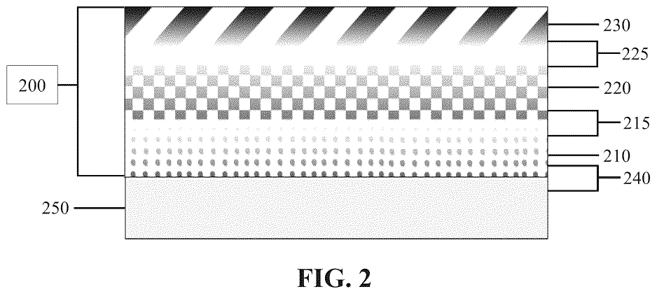

FIG. 2 is an illustration of a cross-sectional view of a heterogeneous multifunctional polymer network stack structure 200 positioned on a polymer substrate 250 in accordance with certain embodiments of the present disclosure. It is noted that stack structure 200 may be substantially similar to stack structure 100 unless presented otherwise herein. As shown, stack structure 200 includes a high hardness surface mechanical zone 210, a shock absorption mechanical zone 220, an adhesive mechanical zone 230, interfacial region 215, interfacial region 225, and interfacial region 240. Stack structure 200, as further shown, is positioned on a polymer substrate 250 and adjacent high hardness surface mechanical zone 210. Polymer substrate 250 may be an optional reinforcement layer included in stack structure 200 that may increase durability of stack structure 200 without compromising the optical properties of stack structure 100. In certain embodiments, polymer substrate 250 may comprise PET. In other embodiments, polymer substrate 250 may comprise any of: colorless polyimide (CPI), COP, and ultra-thin glass (UTG). In order to attach polymer substrate 250 to high hardness surface mechanical zone 210, polymer substrate may be partially cured and high hardness surface mechanical zone 210 may be subsequently coated on top of partially cured polymer substrate 250. It is noted that in relation to the embodiment of FIG. 2, high hardness surface mechanical zone 210, shock absorption mechanical zone 220, adhesive mechanical zone 230, and polymer substrate 250 may be collectively referred to as a heterogeneous multifunctional polymer network stack structure.

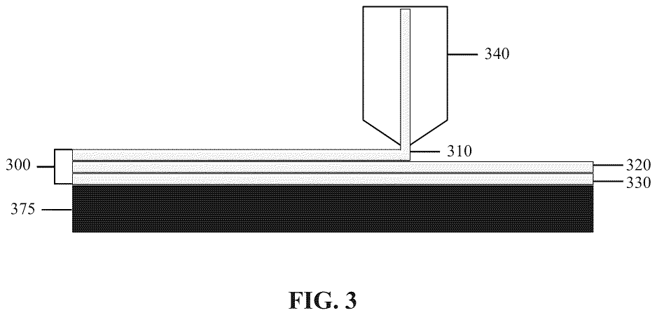

FIG. 3 is an illustration of a cross-sectional view of a heterogeneous multifunctional polymer network stack structure 300 positioned on an OLED display module 375 in accordance with certain embodiments of the present disclosure. It is noted that stack structure 300 is shown positioned upside down in relation to the configurations of stack structures 100,200 so that adhesive mechanical zone 330 is positioned adjacent OLED display module 375. As further shown, stack structure 300 includes a high hardness surface mechanical zone 310, a shock absorption mechanical zone 320, and an adhesive mechanical zone 330. Stack structure 300, as further shown, is coated (as separate layers) onto on a OLED display module 375 via a slot die 340, where adhesive mechanical zone 330 is positioned adjacent OLED display module 375. In order to deposit high hardness surface mechanical zone 310, shock absorption mechanical zone 320, and adhesive mechanical zone 330 onto OLED display module 375, a slot die 340 may be utilized to successively deposit/coat mechanical zones 310,320,330 on top of OLED display module 375. In order to provide proper adherence between stack structure 300 and OLED display module 375, adhesive mechanical zone 330 may be coated on top of OLED display module 375 first so that adhesive mechanical zone 330 may bond to OLED display module 375. In embodiments, OLED display module 375 may be a display module other than OLED and may include, but is not limited to: LCD, LED, QLED, and plasma displays/display modules. In additional embodiments, mechanical zones may be deposited using equipment or techniques other than a slot die and may include, but are not limited to: a gravure cylinder and rod coating.

It is noted that, in relation to any of the embodiments of stack structure disclosed, a first mechanical zone is partially cured. Each of one or more additional mechanical zones are deposited and immediately partially cured once deposited on the mechanical zone it was deposited on. Once all mechanical zones have been deposited, the entire stack structure may be fully cured. As a result of this methodology, a seamless meshing of the mechanical zones may be formed, leading to improved adhesion characteristics and minimal stresses between mechanical zones.

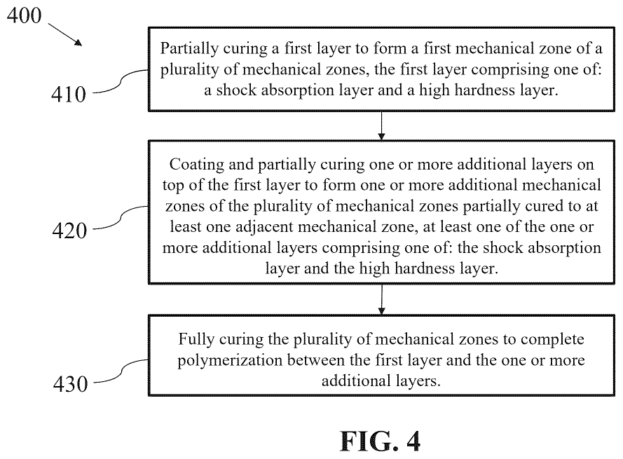

FIG. 4 is an illustration of a method 400 for manufacturing a heterogeneous multifunctional polymer network stack structure in accordance with certain embodiments of the present disclosure. It is noted that the description of method 400 may utilize elements that are disclosed in the descriptions of stack structures 100,200,300 of FIGS. 1-3. As presented, method 400 utilizes a sequential curing process to create a heterogeneous polymer network stack structure having multiple mechanical zones within a single material structure. Method 400 includes partially curing a first layer to form a first mechanical zone of a plurality of mechanical zones, where the first layer comprises one of: a shock absorption layer and a high hardness layer (Block 410). One or more additional layers are each successively coated and partially cured on top of the first layer to form one or more additional mechanical zones of the plurality of mechanical zones (similar to, for example, mechanical zones 120,130) partially cured to at least one adjacent mechanical zone, where at least one of the one or more additional layers comprise one of: the shock absorption layer and the high hardness layer (Block 420). The plurality of mechanical zones is fully cured to complete polymerization between the first layer and the one or more additional layers (Block 430). In additional embodiments, additional mechanical zones may be added to stack structure 100 using the same sequential curing process as previously presented. As a result of the curing process, a unified, single-component stack structure 100 is formed, the structure of which is configured to reduce/eliminate the need for multiple laminated materials.

In an embodiment, at least one of the plurality of mechanical zones comprises a thiol-ene thermoset polymer.

In an embodiment, at least one of the plurality of mechanical zones comprises: a multifunctional thiol compound and at least one of: a multifunctional ethylenically unsaturated compound and a tetrafunctional urethane monomer. In an additional embodiment, the multifunctional thiol compound is selected from: pentaerythritol tetrakis(3-mercaptopropionate), pentaerythritol tetrakis(3-mercaptobutylate), trimethylolpropane tris(3-mercaptopropionate), trimethylolpropane tris(3-mercaptobutylate), dipentaerythritol hexakis (3-mercaptopropionate), and 1,3,5-tris[2-(3-mercaptobutanoyloxy)ethyl]-1,3,5-triazine-2,4,6 (1H,3H,5H)-trione. In an additional embodiment, the multifunctional ethylenically unsaturated compound is selected from: tris(2-acryloyloxyethyl) isocyanurate, trimethylolpropane triacrylate, pentaerythritol triacrylate, dipentaerythritol pentaacrylate, dipentaerythritol hexaacrylate, diallyl phthalate derivatives, and other multifunctional acrylate or allyl-functional monomers capable of participating in thiol-ene polymerization. In a further embodiment, the tetrafunctional urethane monomer is selected from: tetraallyl urethane derivatives, tetraacrylate urethane oligomers, and other urethane-based monomers containing four reactive allyl or acrylate functional groups.

In an embodiment, the fully curing of the plurality of mechanical zones forms an interpenetrating polymer network.

In an embodiment, the plurality of mechanical zones further comprises an additional mechanical zone having high adhesive properties. In a further embodiment, method 400 further comprises structurally bonding the additional mechanical zone to a display module.

In an embodiment, the high hardness layer comprises a Martens hardness greater than 250 MPa.

In an embodiment, method 400 further comprises tuning the plurality of mechanical zones via at least one of: thickness and proportion ratios in order to enhance mechanical performance of the heterogeneous multifunctional polymer network stack structure.

In an embodiment, the partial and full curing may be carried out using UV curing. In other embodiments, the partial and full curing may be carried out using thermal curing. In other embodiments, the partial and full curing may be carried out using both UV curing and thermal curing (during one or both of the partial curing process and the full curing process). It is noted that thermal curing may be utilized depending on the type of initiator and/or curing chemistry employed. It is further noted that UV curing may provide several advantages to the disclosed stack structures. UV curing generally requires lower overall energy input and can be performed locally and in situ, allowing each layer to be partially cured without significantly affecting previously deposited layers. Additionally, UV curing may enable the use of materials with relatively low glass transition temperatures (Tg), which may be beneficial for use in shock absorption zones. In certain applications, such as when the stack structure is formed above OLED devices or other temperature-sensitive electronic components, UV curing is particularly advantageous as UV curing does not pose a threat of damaging the underlying device.

For the purposes of this disclosure, the term “partially curing” may refer to a curing process by which some of a mechanical zone polymer's reactive sites are reacted. This approach allows unreacted reactive sites from an initial mechanical zone to remain available for reaction with subsequently deposited mechanical zones. When a subsequent layer is deposited and a stack structure undergoes further curing (a “full” curing), covalent bonding may occur across the interfacial region between mechanical zones, leading to the formation of an interpenetrating polymer network. As a result of the two part curing, the attachment/transition between adjacent mechanical zones (within interfacial regions) is more gradual rather than forming an abrupt laminated interface. This graded transition may help reduce stress concentration between mechanical zones and improve mechanical durability during bending, folding, or impact events. Additionally, because the mechanical zones are chemically integrated rather than bonded using separate adhesive layers, the resulting stack structure may reduce delamination failure modes that are commonly observed in laminated multilayer structures. The absence of discrete laminated interfaces may also improve optical performance by reducing refractive index discontinuities and minimizing interfacial scattering within the stack structure. It is further noted that a “full cure”, in embodiments, may refer to a curing process by which a layer does not have any remaining unreacted sites at the end of the curing. In additional embodiments, a “full cure” may refer to a curing process by which a layer has been converted at least 95% from a liquid to a solid at the end of the curing.

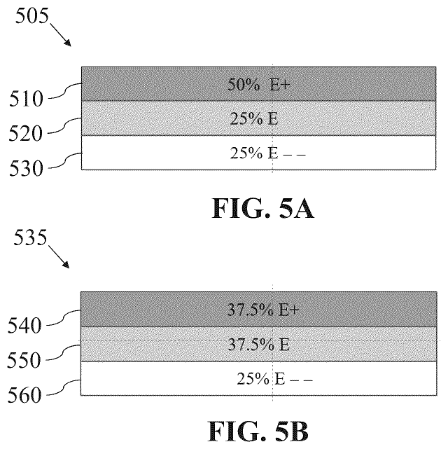

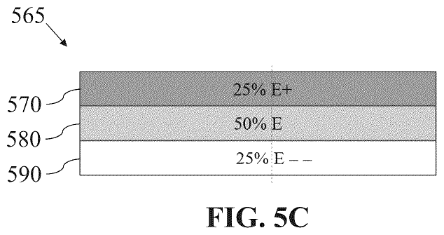

FIGS. 5A-5C are illustrations of cross-sectional views of heterogeneous multifunctional polymer network stack structures 505,535,565 each including mechanical zones with varying elastic moduli in accordance with certain embodiments of the present disclosure. As disclosed, stack structures 505,535,565 may include mechanical zones in which the relative thicknesses of each mechanical zone is varied in order to tune the mechanical response of stack structures 505,535,565. It is noted that zones of heterogeneous multifunctional polymer network stack structures 505,535,565 and heterogeneous multifunctional polymer network stack structure 605 include specific elastic moduli (see Table 1 below):

TABLE 1
Elastic Modulus Scale for Layers of a Heterogeneous
Multifunctional Polymer Network Stack Structure

| Elasticity Marker | Elastic (Young's) Modulus | |
|---|---|---|
| E+ | 2 GPa-3 GPa | |
| E | 1 GPa-2 GPa | |
| E−− | <0.1 | GPa |
| E− | 0.1 GPa-1 GPa | |
| E++ | >3 | GPa |

In relation to the scale presented in Table 1, the markers E, E+, and E− refer to regions having different Young's modulus values, where E represents a baseline modulus, E+ represents a relatively higher modulus region, and E− represents a relatively lower modulus region.

In regard to FIG. 5A, heterogeneous multifunctional polymer network stack structure 505 includes three mechanical zones: a top mechanical zone 510, an intermediate mechanical zone 520, and a bottom mechanical zone 530. Top mechanical zone 510 comprises approximately 50% of the thickness of heterogeneous multifunctional polymer network stack structure 505 and includes an elastic modulus between 2-3 GPa. Intermediate mechanical zone 520 comprises approximately 25% of the thickness of heterogeneous multifunctional polymer network stack structure 505 and includes an elastic modulus between 1-2 GPa. Bottom mechanical zone 530 comprises approximately 25% of the thickness of heterogeneous multifunctional polymer network stack structure 505 and includes an elastic modulus of less than 0.1 GPa. As a result of the configuration of heterogeneous multifunctional polymer network stack structure 505, heterogeneous multifunctional polymer network stack structure 505 may embody a semi-rigid backbone structure, via intermediate mechanical zone 520, which may share strain with bottom mechanical zone 530 during an impact and may also help control the stack structure's bending neutral axis without making stack structure 505 too brittle.

In regard to FIG. 5B, heterogeneous multifunctional polymer network stack structure 535 includes three mechanical zones: a top zone 540, an intermediate mechanical zone 550, and a bottom mechanical zone 560. As shown, stack structure 535 includes a different distribution of thickness than stack structure 505 of FIG. 5A. Specifically, top mechanical zone 540 comprises approximately 37.5% of the thickness of heterogeneous multifunctional polymer network stack structure 535 and includes an elastic modulus between 2-3 GPa. Intermediate mechanical zone 550 comprises approximately 25% of the thickness of heterogeneous multifunctional polymer network stack structure 535 and includes an elastic modulus between 1-2 GPa. Bottom mechanical zone 550 comprises approximately 25% of the thickness of heterogeneous multifunctional polymer network stack structure 535 and includes an elastic modulus of less than 0.1 GPa. As a result of the configuration of heterogeneous multifunctional polymer network stack structure 535, and in relation to heterogeneous multifunctional polymer network stack structure 505, heterogeneous multifunctional polymer network stack structure 535 may, due to a larger intermediate mechanical zone volume, dissipate more strain to its intermediate mechanical zone (intermediate mechanical zone 550) than heterogeneous multifunctional polymer network stack structure 505.

In regard to FIG. 5C, heterogeneous multifunctional polymer network stack structure 565 includes three mechanical zones: a top mechanical zone 570, an intermediate mechanical zone 580, and a bottom mechanical zone 590. As shown, stack structure 535 includes a different distribution of thickness than stack structures 505 and 535 of FIGS. 5A and 5B. Specifically, top mechanical zone 570 comprises approximately 25% of the thickness of heterogeneous multifunctional polymer network stack structure 565 and includes an elastic modulus between 2-3 GPa. Intermediate mechanical zone 580 comprises approximately 50% of the thickness of heterogeneous multifunctional polymer network stack structure 565 and includes an elastic modulus between 1-2 GPa. Bottom mechanical zone 590 comprises approximately 25% of the thickness of heterogeneous multifunctional polymer network stack structure 565 and includes an elastic modulus of less than 0.1 GPa. As a result of the configuration of heterogeneous multifunctional polymer network stack structure 565, and in relation to heterogeneous multifunctional polymer network stack structures 505 and 535, heterogeneous multifunctional polymer network stack structure 565 may, due to a larger intermediate mechanical zone volume, dissipate more strain to its intermediate mechanical zone (intermediate mechanical zone 580) than heterogeneous multifunctional polymer network stack structures 505 and 535.

Overall, stack structures 505,535,565 illustrate that the relative thicknesses of the mechanical zones may be varied while maintaining a monolithic heterogeneous polymer network structure. By adjusting the relative thicknesses of zones having different Young's modulus values, the mechanical response of the stack may be tuned for specific applications including shock absorption, impact resistance, and bending durability.

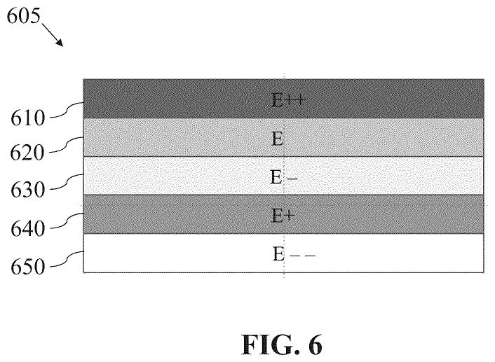

FIG. 6 is an illustration of a cross-sectional view of a heterogeneous multifunctional polymer network stack structure 605 including layers with varying elastic moduli in accordance with certain embodiments of the present disclosure. As shown, heterogeneous multifunctional polymer network stack structure 605 includes five mechanical zones: a top mechanical zone 610, a top intermediate mechanical zone 620, an intermediate mechanical zone 630, a bottom intermediate mechanical zone 640, and a bottom mechanical zone 650. Each of the mechanical zones 610,620,630,640,650 may correspond to a layer of stack structure 605 that provides a different mechanical characteristic. Each of the zones 610,620,630,640,650 also comprise a different elastic modulus (as follows): top mechanical zone 610 comprises an elastic modulus>3 GPa (relatively higher modulus region compared to baseline), top intermediate mechanical zone 620 comprises an elastic modulus between 1 GPa-2 GPa (baseline modulus region), intermediate mechanical zone 630 comprises an elastic modulus between 0.1 GPa-1 GPa (relatively lower modulus region compared to baseline), bottom intermediate mechanical zone 640 comprises an elastic modulus between 2 GPa-3 GPa (moderately increased modulus region compared to baseline), and bottom mechanical zone 650 comprises an elastic modulus<0.1 GPa (relatively low modulus region compared to baseline).

Mechanical zones 610,620,630,640,650 may be sequentially deposited and partially cured according to the curing processes described herein such that the resulting structure forms a single integrated heterogeneous polymer network rather than a laminated multilayer structure. This exemplary stack structure (stack structure 605) may further illustrate that the number of mechanical zones within a stack may vary and may be increased to create more gradual transitions in mechanical properties across a thickness of a stack structure. Such modulus grading may help distribute mechanical stresses more effectively across a stack structure and may improve characteristics such as, but not limited to: shock absorption behavior, bending durability, and resistance to mechanical stress concentration. Additionally, the transition between mechanical zones may occur through discrete regions (interfacial regions) or may form gradual gradients in mechanical properties across the thickness of a stack structure (for example due to partial interpenetration of polymer networks during sequential curing steps).

It is noted that in relation to the heterogeneous multifunctional polymer network stack structures as disclosed, properties of the heterogeneous multifunctional polymer network stack structures may be tuned/optimized by varying the thicknesses, relative ratios, and/or sequence of the mechanical zones of the heterogeneous multifunctional polymer network stack structures. For example, properties that may be tuned/optimized include, but are not limited to: shock absorption, hardness, and bending resistance. As a result, heterogeneous multifunctional polymer network stack structures may be produced that can achieve certain modulus grades and shock absorption while embodying a single monolithic heterogeneous polymer network.

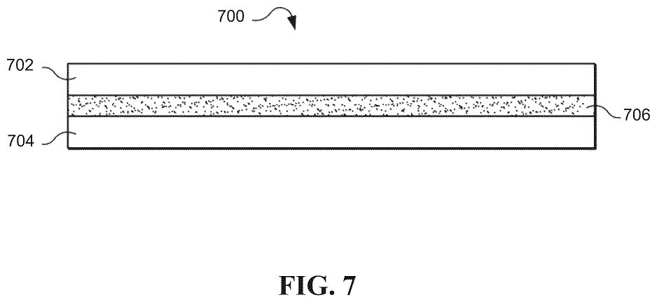

FIG. 7 is an illustration of a cross-sectional view of an optical laminate 700 in accordance with certain embodiments of the present disclosure. As shown, optical laminate 700 includes an adhesive layer 706 positioned between and in contact with a first surface of a first base layer 702 and a second surface of a second base layer 704. Adhesive layer 706 may be in direct contact with the first surface of the first base layer 702 and the second surface of the second base layer 704. In other embodiments, adhesive layer 706 may be in indirect contact with the first surface of the first base layer 702 and the second surface of the second base layer 704, where one or more additional layers (not depicted) are positioned between adhesive layer 706 and the first surface of the first base layer 702 and between adhesive layer 706 and the second surface of the second base layer 704. The additional layers may include layers such as, but not limited to, hard coat layers, primer layers, polarizing layers, light emitting layers, or color filter layers. It is further noted that either or both of first base layer 702/second base layer 704 may comprise any embodiment of a heterogeneous multifunctional polymer network stack structure as disclosed herein.

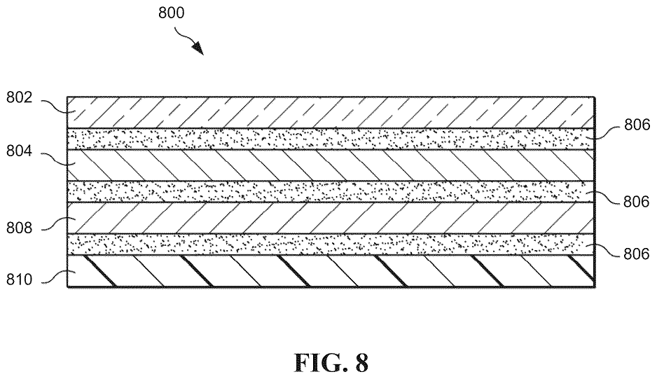

FIG. 8 is an illustration of a cross-sectional view of a flexible display 800 in accordance with certain embodiments of the present disclosure. As shown, flexible display 800 includes a plurality of layers generally associated with a flexible display and includes a window layer 802, a polarizer layer 804, a display layer 808, and a support film layer 810. An adhesive layer 806 is positioned between each pair of layers (802/804, 804/808, and 808/810). More specifically, one adhesive layer 806 of a plurality of adhesive layers 806 is positioned between and in contact with a first surface of window layer 802 and a first surface of polarizer layer 804, another adhesive layer 806 is positioned between and in contact with a second surface of polarizer layer 804 and a first surface of display layer 808, and another adhesive layer 806 is positioned between and in contact with a second surface of display layer 808 and a first surface of support film layer 810. It is further noted that any of: window layer 802, polarizer layer 804, display layer 808, and support film layer 810 may comprise any embodiment of a heterogeneous multifunctional polymer network stack structure as disclosed herein.

In other embodiments, adhesive layers 806 may be in indirect contact with the first surface of window layer 802, the first surface of polarizer layer 804, the second surface of polarizer layer 804, the first surface of display layer 808, the second surface of display layer, and the first surface of support film layer 810, where one or more additional layers (not depicted) are positioned between adhesive layers 806 and the first surface of window layer 802, the first surface of polarizer layer 804, the second surface of polarizer layer 804, the first surface of display layer 808, the second surface of display layer, and the first surface of support film layer 810. The additional layers may include layers such as, but not limited to, hard coat layers, primer layers, polarizing layers, light emitting layers, or color filter layers. It is noted that additional layers that are utilized in a flexible display and are separated by additional adhesive layers 806 can be included in the embodiment of flexible display 800, which can be recognized and understood by one skilled in the art.

It is noted that each mechanical zone may, in embodiments, include one or more additional compounds/additives. At least some of these compounds/additives may be presented and described in the “EXAMPLES” section below.

### EXAMPLES

The invention is further described in the following examples, which are included for the purpose of illustration and are not intended to limit the scope of this invention in any way. The parts of each component are given in weight percentage of the total weight of the composition.

### Example 1

A First Exemplary Heterogeneous Multifunctional Polymer Network Stack Structure for Displays.

A shock absorption mechanical zone is formed by partially curing a composition comprising 29.0-67.6 wt % of a multifunctional thiol compound (such as, for example, pentaerythritol tetrakis(3-mercaptopropionate)) and 30.1-70.3 wt % of a multifunctional ethylenically unsaturated compound (such as, for example, N-acryloyl-1,6-hexanediamine triazine-based urethane). The curable composition also contains 0.6-1.4 wt % of a photoinitiator (such as, for example, bis(2,4,6-trimethylbenzoyl)-phenylphosphine oxide) and 0.3-0.7 wt % of a stabilizer (such as, for example, butylated hydroxytoluene). This composition is partially cured using a Fusion D bulb at a dose of 2 J/cm², preserving some reactive groups to allow for chemical bonding with a high hardness mechanical zone.

The high hardness mechanical zone is formed by curing a composition comprising 16.3-38.1 wt % of a multifunctional thiol compound (such as, for example, 1,3,5-Tris[2-(3-mercaptobutanoyloxy)ethyl]-1,3,5-triazine-2,4,6 (1H,3H,5H)-trione), 7.16-16.72 wt % of a multifunctional ethylenically unsaturated compound (such as, for example, tris(2-acryloyloxyethyl) isocyanurate), and 36.51-85.19 wt % of a multifunctional crosslinking agent (such as, for example, tris(2-acryloyloxyethyl) cyanurate). The curable composition also contains 0.45-1.05 wt % of a photoinitiator (such as, for example, bis(2,4,6-trimethylbenzoyl)-phenylphosphine oxide) and 0.06-0.14 wt % of a stabilizer (such as, for example, butylated hydroxytoluene). This composition is fully cured using a Fusion D bulb at a dose of 5 J/cm² on top of the partially cured shock absorption mechanical zone, ensuring complete polymerization and integration into a continuous heterogeneous polymer network.

Once cured, the polymer network stack structure is released from a substrate and can be laminated onto a display module using a compatible optically clear adhesive (OCA). Exemplary OCAs may include, in embodiments: epoxy clear adhesives, acrylate based adhesives, and/or thiol based adhesives. Additionally, a thin hard coat layer may be applied to the high hardness mechanical zone to further enhance scratch resistance while maintaining optical clarity.

### Example 2

A Second Exemplary Heterogeneous Multifunctional Polymer Network Stack Structure for Displays.

A heterogeneous multifunctional polymer network stack structure for displays comprises a high hardness mechanical zone formed on top of a shock absorption mechanical zone, where a PET substrate is integrated into the stack structure as part of the final component. This thin PET substrate remains in the display stack, contributing to the mechanical integrity of the display module, rather than being removed after processing.

A shock absorption mechanical zone is formed by curing a composition comprising 29.0-67.6 wt % of a multifunctional thiol compound (such as, for example, pentaerythritol tetrakis(3-mercaptopropionate)) and 30.1-70.3 wt % of a multifunctional ethylenically unsaturated compound (such as, for example, N-acryloyl-1,6-hexanediamine triazine-based urethane). The curable composition also contains 0.6-1.4 wt % of a photoinitiator (such as, for example, bis(2,4,6-trimethylbenzoyl)-phenylphosphine oxide) and 0.3-0.7 wt % of a stabilizer (such as, for example, butylated hydroxytoluene). This composition is partially cured using a Fusion D bulb at a dose of 2 J/cm², preserving some reactive groups to allow for chemical bonding with a high hardness mechanical zone.

The high hardness mechanical zone is formed by curing a composition comprising 16.3-38.1 wt % of a multifunctional thiol compound (such as, for example, 1,3,5-Tris[2-(3-mercaptobutanoyloxy)ethyl]-1,3,5-triazine-2,4,6 (1H,3H,5H)-trione), 7.16-16.72 wt % of a multifunctional ethylenically unsaturated compound (such as, for example, tris(2-acryloyloxyethyl) isocyanurate), and 36.51-85.19 wt % of a multifunctional crosslinking agent (such as, for example, tris(2-acryloyloxyethyl) cyanurate). The curable composition also contains 0.45-1.05 wt % of a photoinitiator (such as, for example, bis(2,4,6-trimethylbenzoyl)-phenylphosphine oxide) and 0.06-0.14 wt % of a stabilizer (such as, for example, butylated hydroxytoluene). This composition is fully cured using a Fusion D bulb at a dose of 5 J/cm² on top of the partially cured shock absorption mechanical zone, enabling complete polymerization and integration into a continuous heterogeneous polymer network.

Unlike Example 1, where the substrate is removed after curing, in this embodiment, the thin PET substrate remains as a functional part of the display stack, enhancing the overall mechanical structure of the display module. The polymer network stack structure is laminated onto the display module using a compatible optically clear adhesive (OCA). Additionally, a thin hard coat layer may be applied to the high hardness mechanical zone to further enhance scratch resistance while maintaining optical clarity.

### Example 3

### A Third Exemplary Heterogeneous Multifunctional Polymer Network Stack Structure for Displays.

A heterogeneous multifunctional polymer network stack structure utilized for displays comprises a high hardness mechanical zone formed on top of a shock absorption mechanical zone, where the material is directly coated onto an OLED display module. This embodiment provides in situ coating and curing, eliminating the need for a separate substrate and providing direct integration of the protective polymer network onto the display.

The shock absorption mechanical zone is formed by curing a composition comprising 36.7-85.7 wt % of a multifunctional thiol compound (such as, for example, pentaerythritol tetrakis(3-mercaptobutylate)) and 22.4-52.2 wt % of a multifunctional ethylenically unsaturated compound (such as, for example, tris(2-acryloyloxyethyl) isocyanurate). The curable composition also contains 0.6-1.4 wt % of a photoinitiator (such as, for example, bis(2,4,6-trimethylbenzoyl)-phenylphosphine oxide), and 0.3-0.7 wt % of a stabilizer (such as, for example, butylated hydroxytoluene). This composition is partially cured using a Fusion D bulb at a dose of 2 J/cm² preserving some reactive groups to allow for chemical bonding with the high hardness mechanical zone.

The high hardness mechanical zone is formed by curing a composition comprising 11.9-27.7 wt % of a multifunctional thiol compound (such as, for example, pentaerythritol tetrakis(3-mercaptobutylate)), 33.9-79.1 wt % of a multifunctional crosslinking agent (such as, for example, tris(2-acryloyloxyethyl) cyanurate) and 32.2-75.2 wt % of a tetrafunctional urethane monomer (such as, for example, tetraallyldiurethane). The curable composition also contains 0.6-1.4 wt % of a photoinitiator (such as, for example, bis(2,4,6-trimethylbenzoyl)-phenylphosphine oxide, and 0.3-0.7 wt % of a stabilizer (such as, for example, butylated hydroxytoluene). This composition is fully cured using a Fusion D bulb at a dose of 5 J/cm², ensuring complete polymerization and integration into a continuous heterogeneous polymer network.

Unlike Embodiments 1 and 2, where the mechanical zones are formed on a substrate/PET substrate before integration into the display module, in Embodiment 3, the material is directly coated and cured onto the OLED display module. This eliminates the need for additional lamination steps, reduces processing complexity, and provides direct mechanical reinforcement to the display surface. Additionally, a thin hardcoat layer may be applied to the high hardness mechanical zone to further enhance scratch resistance while maintaining optical clarity.

### Example 4

A Fourth Exemplary Heterogeneous Multifunctional Polymer Network Stack Structure for Displays.

A heterogeneous multifunctional polymer network stack structure for displays comprises three distinct mechanical zones—an adhesive mechanical zone, a shock absorption mechanical zone, and a high hardness mechanical zone-all forming a single heterogeneous polymer network. Unlike Embodiment 3, where the material is coated directly onto an OLED display module, this embodiment returns to using the same substrate as Embodiment 1. The incorporation of a thiol-based optically clear adhesive (OCA) as the first mechanical zone provides seamless integration into display stacks without requiring a separate adhesive layer.

The adhesive mechanical zone is formed by curing a composition comprising a thiol-based optically clear adhesive (OCA). This composition is partially cured using a Fusion D bulb at a dose of 2 J/cm², allowing the subsequent mechanical zones to chemically bond and form a single polymer network.

The shock absorption mechanical zone is formed by curing a composition comprising 36.7-85.7 wt % of a multifunctional thiol compound (such as, for example, pentaerythritol tetrakis(3-mercaptobutylate)) and 22.4-52.2 wt % of a multifunctional ethylenically unsaturated compound (such as, for example, tris(2-acryloyloxyethyl) isocyanurate). The curable composition also contains 0.6-1.4 wt % of a photoinitiator (such as, for example, bis(2,4,6-trimethylbenzoyl)-phenylphosphine oxide and 0.3-0.7 wt % of a stabilizer (such as, for example, butylated hydroxytoluene). This composition is partially cured to allow controlled bonding with the high hardness mechanical zone.

The high hardness mechanical zone is formed by curing a composition comprising 11.9-27.7 wt % of a multifunctional thiol compound (such as, for example, pentaerythritol tetrakis(3-mercaptobutylate)), 33.9-79.1 wt % of a multifunctional crosslinking agent (such as, for example, tris(2-acryloyloxyethyl) cyanurate), and 32.2-75.2 wt % of a tetrafunctional urethane monomer (such as, for example, tetraallyldiurethane). The curable composition also contains 0.6-1.4 wt % of a photoinitiator (such as, for example, bis(2,4,6-trimethylbenzoyl)-phenylphosphine oxide) and 0.3-0.7 wt % of a stabilizer (such as, for example, butylated hydroxytoluene. This composition is fully cured using a Fusion D bulb at a dose of 5 J/cm², enabling complete polymerization and integration into the continuous heterogeneous polymer network.

The three mechanical zones together form a single polymer network, eliminating interfaces between adhesives, shock-absorbing materials, and hard coatings that are typically laminated separately in conventional display stacks. This structure provides seamless optical and mechanical integration, reducing failure points while improving adhesion, impact resistance, and surface hardness. Additionally, a thin hard coat layer may be applied to the high hardness mechanical zone to further enhance scratch resistance while maintaining optical clarity.

It is noted that the optically clear adhesives (OCAs)/polymeric resins/heterogeneous multifunctional polymer network stack structures presented herein may be utilized in a display/display device/display panel that may be flexible or inflexible. The optically clear adhesives (OCAs)/polymeric resins/heterogeneous multifunctional polymer network stack structures may be incorporated into one or more layers of the display/display device/display panel that include, but are not limited to: a seal layer, a cathode layer, an emissive layer, an adhesive layer, a conductive layer, an anode layer, a substrate layer, and any layers mentioned in reference to FIG. 6. It is understood that the display/display device/display panel may include additional film layers that are not mentioned herein.

In an embodiment of the present disclosure, an electronic device may be provided that may utilize one or more optically clear adhesives (OCAs)/polymeric resins/heterogeneous multifunctional polymer network stack structures of the present disclosure in a display/display device/display panel associated with the electronic device. For exemplary purposes, the electronic device may be any of: a smart phone, a mobile phone, a video phone, a camera, a wearable device (such as electronic clothing, an electronic accessory, a smart watch, a head-mounted apparatus, an electronic bracelet, an electronic necklace, or an electronic tattoo), a personal digital assistant (PDA), a desktop computer (PC), a laptop PC, a netbook PC, a portable multimedia player (PMP), a digital audio player, a mobile medical apparatus, an e-book reader, etc. In additional embodiments, the electronic device may be a smart home appliance including a display/display device/display panel. For exemplary purposes, the smart home appliance may be any of: an electronic key, a stereo, a TV, a set-top box, a television (TV) box, a video recorder, a game console, a vacuum cleaner, a digital video disk (DVD) player, a refrigerator, an air conditioner, an oven, a dryer, an air purifier, a microwave oven, a washing machine, an electronic dictionary, an electronic photo frame, etc.

As a result of the mechanical properties of embodiments of the heterogeneous multifunctional polymer network stack structure disclosed, the stack structure may provide multiple benefits. As a result of the stack structure's unified window construction, interfaces between materials may be eliminated, thus reducing failure points. As a result of the stack structure's refractive index matching (between zones), seamless optical performance is provided, which may prevent light distortion and may ensure vivid colors and deep blacks. As a result of the stack structure's construction, crease formation is prevented as the stack structure may maintain a smooth, clear surface even after repeated folding cycles. As a result of the stack structure's physical configuration, multiple functional mechanical zones may enable hardness, shock absorption, and adhesion in a single material, allowing for customization of the stack structure's mechanical properties. As a result of the stack structure's physical configuration, the stack structure may embody high durability characteristics that include withstanding over 200,000 bending cycles at a 0.5 mm-4 mm radius in extreme temperatures (−25° C. to 65° C.). As a result of the stack structure's material makeup, the processing of the stack structure may be sustainable and solvent-free. Specifically, the processing of the stack structure includes the utilization of UV-curing of thiol-ene chemistry, which may reduce energy consumption.

It is noted that, in relation to the disclosed heterogeneous multifunctional polymer network stack structures that include a single monolithic heterogeneous polymer network, the relative thicknesses or proportions of the mechanical zones found in the heterogeneous multifunctional polymer network stack structures can be deliberately tuned/varied in order to enhance/optimize mechanical performance of the polymer network. Aspects of mechanical performance may include, but are not limited to: shock absorption, hardness, and bending resistance. As a result of the tuning/alteration of the mechanical zones, the heterogeneous multifunctional polymer network stack structures may embody mechanical performance characteristics that are equal to or greater than a laminated polymer network stack structure.

It is further noted that the ASTM D3359 Cross-hatch Adhesion Test has been carried out on stack structures fabricated using the disclosed partial curing methodology. It was found that when different materials used in layers of stack structures (that are deposited and cured using the disclosed curing process) is tested using the adhesion test, the stack structures consistently showed adhesion ratings of 5B, which indicates very strong adhesion between the mechanical zones.

It is further noted that the minimum energy required to partially cure each layer in a stack structure may depend on the type of photoinitiator and formulation used in each layer. In certain embodiments, partial curing processes may utilize exposures ranging from approximately 30% to 70% of the energy dose typically used for a full curing process, which may leave a sufficient amount of unreacted reactive sites (approximately 5%-50%) in a layer while also providing adequate structural integrity for subsequent coating steps. As long as a sufficient number of reactive functional groups/reactive sites remain unreacted after the partial curing process, subsequent deposition/coating and curing of additional layers allows the layers to chemically integrate. As a result of the percent of reactive sites being unreacted (as denoted above), subsequent/adjacent layers are able to chemically bond and interpenetrate with previously deposited zones during the final curing process.

It is further noted that any of the disclosed mechanical zones/layers may comprise a hardness that may be defined using any of: Martens hardness, pencil hardness, or any other comparable hardness measurement systems.

One or more embodiments of this disclosure present materials for constructing higher quality and higher performing flexible display technologies in relation to other flexible display technologies.

For the purposes of this disclosure, the terms “polymer network”, “network”, “stack”, “stack structure”, “polymer stack structure”, “polymeric stack structure”, “polymer network stack structure”, and “heterogeneous multifunctional polymer network stack structure” may be synonymous, unless otherwise noted. It is noted that, in certain instances, one or more of the aforementioned terms may refer to a generic polymeric stack structure that may not be chemically bonded using curing processes as described herein.

For the purposes of this disclosure, the terms “zone” and “mechanical zone” may be synonymous.

For the purposes of this disclosure, it may be understood that a mechanical zone may comprise a layer made of one or more polymers.

In embodiments, a configuration of a heterogeneous multifunctional polymer network stack structure may include an adhesive mechanical zone positioned on one side of the stack structure (for example, facing and configured to bond to a display module or another type of substrate), while a high hardness mechanical zone is positioned on an opposing side of the stack structure (for example, forming an exterior surface that provides scratch resistance and mechanical protection). Between these two sides, the stack structure may include one or more additional mechanical zones, including shock absorption mechanical zones and/or intermediate modulus transition mechanical zones, which may be used to tune the mechanical response of the stack structure and create a gradual modulus gradient across the thickness of the stack structure. In some embodiments, multiple shock absorption mechanical zones may be included between an adhesive mechanical zone and a high hardness mechanical zone to further improve energy dissipation, reduce stress concentration, and improve durability under repeated bending or impact conditions.

In certain embodiments, thiol-ene polymers may be a main component of mechanical zones of the heterogeneous multifunctional polymer network stack structures disclosed and may be included in one or more mechanical zones of the heterogeneous multifunctional polymer network stack structures.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, a heterogeneous multifunctional polymer network stack structure, comprising: a plurality of mechanical zones, wherein the plurality of mechanical zones includes at least: a shock absorption layer; and a high hardness layer; wherein each mechanical zone of the plurality of mechanical zones is partially cured to at least one adjacent mechanical zone, wherein the partial curing partially chemically bonds each of the mechanical zones to the at least one adjacent mechanical zone.

Clause 2, the stack structure of Clause 1, wherein at least one of the plurality of mechanical zones comprises a thiol-ene thermoset polymer.

Clause 3, the stack structure of Clause 1, wherein at least one of the plurality of mechanical zones comprises: a multifunctional thiol compound and at least one of: a multifunctional ethylenically unsaturated compound and a tetrafunctional urethane monomer.

Clause 4, the stack structure of Clause 3, wherein the multifunctional thiol compound is selected from: pentaerythritol tetrakis(3-mercaptopropionate), pentaerythritol tetrakis(3-mercaptobutylate), trimethylolpropane tris(3-mercaptopropionate), trimethylolpropane tris(3-mercaptobutylate), dipentaerythritol hexakis (3-mercaptopropionate), and 1,3,5-tris[2-(3-mercaptobutanoyloxy)ethyl]-1,3,5-triazine-2,4,6 (1H,3H,5H)-trione.

Clause 5, the stack structure of Clause 3, wherein the multifunctional ethylenically unsaturated compound is selected from: tris(2-acryloyloxyethyl) isocyanurate, trimethylolpropane triacrylate, pentaerythritol triacrylate, dipentaerythritol pentaacrylate, dipentaerythritol hexaacrylate, and diallyl phthalate derivatives.

Clause 6, the stack structure of Clause 1, wherein the plurality of mechanical zones is fully cured after the partial curing of each of the mechanical zones of the plurality of mechanical zones to form an interpenetrating polymer network.

Clause 7, the stack structure of Clause 1, wherein the plurality of mechanical zones further comprises an additional mechanical zone having high adhesive properties.

Clause 8, the stack structure of Clause 7, wherein the additional mechanical zone is configured to structurally bond to a display module.

Clause 9, the stack structure of Clause 1, wherein the high hardness layer comprises a Martens hardness greater than 250 MPa.

Clause 10, the stack structure of Clause 1, wherein the plurality of mechanical zones is tunable via thickness and proportion ratios in order to enhance mechanical performance of the heterogeneous multifunctional polymer network stack structure.

Clause 11, a method for manufacturing a heterogeneous multifunctional polymer network stack structure, comprising: partially curing a first layer to form a first mechanical zone of a plurality of mechanical zones, the first layer comprising one of: a shock absorption layer and a high hardness layer; coating and partially curing one or more additional layers on top of the first layer to form one or more additional mechanical zones of the plurality of mechanical zones partially cured to at least one adjacent mechanical zone, at least one of the one or more additional layers comprising one of: the shock absorption layer and the high hardness layer; and fully curing the plurality of mechanical zones to complete polymerization between the first layer and the one or more additional layers.

Clause 12, the method of Clause 11, wherein at least one of the plurality of mechanical zones comprises a thiol-ene thermoset polymer.

Clause 13, the method of Clause 11, wherein at least one of the plurality of mechanical zones comprises: a multifunctional thiol compound and at least one of: a multifunctional ethylenically unsaturated compound and a tetrafunctional urethane monomer.

Clause 14, the method of Clause 13, wherein the multifunctional thiol compound is selected from: pentaerythritol tetrakis(3-mercaptopropionate), pentaerythritol tetrakis(3-mercaptobutylate), trimethylolpropane tris(3-mercaptopropionate), trimethylolpropane tris(3-mercaptobutylate), dipentaerythritol hexakis (3-mercaptopropionate), and 1,3,5-tris[2-(3-mercaptobutanoyloxy)ethyl]-1,3,5-triazine-2,4,6 (1H,3H,5H)-trione.

Clause 15, the method of Clause 13, wherein the multifunctional ethylenically unsaturated compound is selected from: tris(2-acryloyloxyethyl) isocyanurate, trimethylolpropane triacrylate, pentaerythritol triacrylate, dipentaerythritol pentaacrylate, dipentaerythritol hexaacrylate, and diallyl phthalate derivatives.

Clause 16, the method of Clause 11, wherein the fully curing of the plurality of mechanical zones forms an interpenetrating polymer network.

Clause 17, the method of Clause 11, wherein the plurality of mechanical zones further comprises an additional mechanical zone having high adhesive properties.

Clause 18, the method of Clause 17, further comprising structurally bonding the additional mechanical zone to a display module.

Clause 19, the method of Clause 11, wherein the high hardness layer comprises a Martens hardness greater than 250 MPa.

Clause 20, the method of Clause 11, further comprising tuning the plurality of mechanical zones via at least one of: thickness and proportion ratios in order to enhance mechanical performance of the heterogeneous multifunctional polymer network stack structure.

What is claimed is:

1. A heterogeneous multifunctional polymer network stack structure, comprising:
a plurality of mechanical zones, wherein the plurality of mechanical zones includes at least:
a shock absorption layer; and
a high hardness layer;
wherein each mechanical zone of the plurality of mechanical zones is partially cured to at least one adjacent mechanical zone, wherein the partial curing partially chemically bonds each of the mechanical zones to the at least one adjacent mechanical zone.

2. The stack structure of claim 1, wherein at least one of the plurality of mechanical zones comprises a thiol-ene thermoset polymer.

3. The stack structure of claim 1, wherein at least one of the plurality of mechanical zones comprises: a multifunctional thiol compound and at least one of: a multifunctional ethylenically unsaturated compound and a tetrafunctional urethane monomer.

4. The stack structure of claim 3, wherein the multifunctional thiol compound is selected from: pentaerythritol tetrakis(3-mercaptopropionate), pentaerythritol tetrakis(3-mercaptobutylate), trimethylolpropane tris(3-mercaptopropionate), trimethylolpropane tris(3-mercaptobutylate), dipentaerythritol hexakis (3-mercaptopropionate), and 1,3,5-tris[2-(3-mercaptobutanoyloxy)ethyl]-1,3,5-triazine-2,4,6 (1H,3H,5H)-trione.

5. The stack structure of claim 3, wherein the multifunctional ethylenically unsaturated compound is selected from: tris(2-acryloyloxyethyl) isocyanurate, trimethylolpropane triacrylate, pentaerythritol triacrylate, dipentaerythritol pentaacrylate, dipentaerythritol hexaacrylate, and diallyl phthalate derivatives.

6. The stack structure of claim 1, wherein the plurality of mechanical zones is fully cured after the partial curing of each of the mechanical zones of the plurality of mechanical zones to form an interpenetrating polymer network.

7. The stack structure of claim 1, wherein the plurality of mechanical zones further comprises an additional mechanical zone having high adhesive properties.

8. The stack structure of claim 7, wherein the additional mechanical zone is configured to structurally bond to a display module.

9. The stack structure of claim 1, wherein the high hardness layer comprises a Martens hardness greater than 250 MPa.

10. The stack structure of claim 1, wherein the plurality of mechanical zones is tunable via thickness and proportion ratios in order to enhance mechanical performance of the heterogeneous multifunctional polymer network stack structure.

11. A method for manufacturing a heterogeneous multifunctional polymer network stack structure, comprising:
partially curing a first layer to form a first mechanical zone of a plurality of mechanical zones, the first layer comprising one of: a shock absorption layer and a high hardness layer;
coating and partially curing one or more additional layers on top of the first layer to form one or more additional mechanical zones of the plurality of mechanical zones partially cured to at least one adjacent mechanical zone, at least one of the one or more additional layers comprising one of: the shock absorption layer and the high hardness layer; and
fully curing the plurality of mechanical zones to complete polymerization between the first layer and the one or more additional layers.

12. The method of claim 11, wherein at least one of the plurality of mechanical zones comprises a thiol-ene thermoset polymer.

13. The method of claim 11, wherein at least one of the plurality of mechanical zones comprises: a multifunctional thiol compound and at least one of: a multifunctional ethylenically unsaturated compound and a tetrafunctional urethane monomer.

14. The method of claim 13, wherein the multifunctional thiol compound is selected from: pentaerythritol tetrakis(3-mercaptopropionate), pentaerythritol tetrakis(3-mercaptobutylate), trimethylolpropane tris(3-mercaptopropionate), trimethylolpropane tris(3-mercaptobutylate), dipentaerythritol hexakis (3-mercaptopropionate), and 1,3,5-tris[2-(3-mercaptobutanoyloxy)ethyl]-1,3,5-triazine-2,4,6 (1H,3H,5H)-trione.

15. The method of claim 13, wherein the multifunctional ethylenically unsaturated compound is selected from: tris(2-acryloyloxyethyl) isocyanurate, trimethylolpropane triacrylate, pentaerythritol triacrylate, dipentaerythritol pentaacrylate, dipentaerythritol hexaacrylate, and diallyl phthalate derivatives.

16. The method of claim 11, wherein the fully curing of the plurality of mechanical zones forms an interpenetrating polymer network.

17. The method of claim 11, wherein the plurality of mechanical zones further comprises an additional mechanical zone having high adhesive properties.

18. The method of claim 17, further comprising structurally bonding the additional mechanical zone to a display module.

19. The method of claim 11, wherein the high hardness layer comprises a Martens hardness greater than 250 MPa.

20. The method of claim 11, further comprising tuning the plurality of mechanical zones via at least one of: thickness and proportion ratios in order to enhance mechanical performance of the heterogeneous multifunctional polymer network stack structure.
